(19) United States
(12) Patent Application Publication
(10) Pub. No.: US 2026/0238080 A1
(43) Pub. Date: Aug. 13, 2026

(54) ELECTRIC DRIVE DEVICE FOR A MOTOR VEHICLE

(71) Applicant: MERCEDES-BENZ GROUP AG, Stuttgart (DE)

(72) Inventors: Tobias SCHILDER, Ludwigsburg (DE); Tobias HAERTER, Stuttgart (DE)

(21) Appl. No.: 19/122,320

(22) PCT Filed: Oct. 12, 2023
(86) PCT No.: PCT/EP2023/078415

§ 371 Date: Apr. 16, 2026

(30) Foreign Application Priority Data
Oct. 20, 2022 (DE) 10 2022 003 897.8

(51) Int. Cl. H02K 7/116; F16H 3/54

(52) U.S. Cl. CPC H02K 7/116; F16H 3/54; F16H 2200/2082

(57) ABSTRACT

An electric drive device for a motor vehicle includes an electric motor having a rotor, a planetary transmission stage having a sun gear, a planet carrier with planet gears, and a ring gear, a switchable overrunning clutch, which has first and second coupling halves, a switching element, and an actuator. The first coupling half is non-rotatably connected to a housing. The second coupling half is non-rotatably connected to the ring gear. A connecting element non-rotatably connected to the ring gear and non-rotatably connected to the second coupling half is arranged radially between a sun gear toothing of the sun gear and a ring gear toothing of the ring gear with respect to an axis of rotation of the planetary transmission stage.

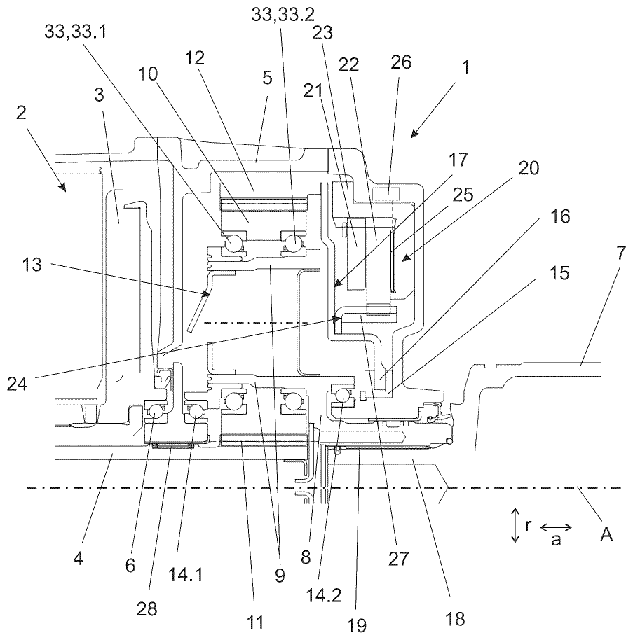

### BACKGROUND AND SUMMARY OF THE INVENTION

Exemplary embodiments of the invention relate to an electric drive device for a motor vehicle.

DE 10 2019 114 139 B3 describes prior art in the form of a motor vehicle transmission for coupling an electric motor to a drive train. A planetary transmission stage with a sun gear, a planet carrier with planet gears, and a ring gear is provided between the electric motor and the drive train. Furthermore, a switchable freewheel is arranged in the vehicle transmission, which is able to switchably couple the sun gear with a reference component, in particular a fixed housing, via two coupling halves in such a way that freewheeling and/or locking of the sun gear relative to the housing is optionally brought about. A very similar electric drive device is shown in the generic document DE 10 2015 110 565 A1, in which, in addition, a connecting element is provided that is non-rotatably connected to the ring gear and non-rotatably connected to one of the coupling halves, which connecting element in turn has a cylinder section arranged coaxially to an axis of rotation of the planetary transmission stage.

Exemplary embodiments of the present invention are directed to an electric drive device for a motor vehicle which further improves the said prior art design by simplifying the design such that installation space, components and costs can be saved.

The embodiment of the electric drive device for a motor vehicle provides, in a manner known per se, that the second coupling half of the switchable overrunning clutch is non-rotatably connected to the ring gear, wherein a connecting element non-rotatably connected to the ring gear and non-rotatably connected to the second coupling half is arranged radially between a sun gear toothing of the sun gear and a ring gear toothing of the ring gear with respect to an axis of rotation of the planetary transmission stage.

In the sense of the invention, a non-rotatable connection is to be understood as any connection ensuring the coaxially arranged elements connected in a non-rotatable manner rotate at the same angular velocity about a common axis of rotation.

The switchable freewheel between the ring gear and the housing is very cleverly designed and enables an easy-to-install and very compact design of the electric drive device. The arrangement of the connecting element in its radial position between the sun gear toothing and the ring gear toothing thus ensures a very compact design of the electric drive device in the radial direction.

The connecting element also has a cylinder section arranged coaxially to the axis of rotation of the planetary transmission stage in a manner known per se.

In accordance with the invention, the cylinder section is arranged radially in relation to the axis of rotation in an area of the planetary gear pins of the transmission stage carrying the planet carriers. The cylinder section is therefore located radially next to this planetary gear pin of the planet carrier, on which the planet gears are arranged accordingly. This ensures a compact design in which the cylinder section is nested within the switchable coupling and in which the axial guide ring and a corresponding guide section of the disc unit are particularly preferably again arranged axially within this cylinder section and overlapping with it. This enables a very compact design.

Furthermore, in accordance with the invention, it is provided that the ring gear is designed without its own rolling bearing directly supporting the ring gear, i.e., without a transmission element arranged in between, and is only supported in both axial directions via an axial guide ring. The inventors utilize the fact that with a radial bearing, wherein radial always refers to the central axis of the planetary transmission, the third shaft of two shafts of the planetary transmission does not have to be supported radially. A rolling bearing for the ring gear, which is the component with the relatively largest diameter of the planetary transmission, can therefore be dispensed with. This saves the costs, installation space and weight of a relatively large rolling bearing.

The ring gear itself is centered via the shafts of the two other elements of the planetary transmission, i.e., the planetary gear carrier and the sun gear. The axial guide ring of the invention then only serves to ensure that the ring gear does not move substantially axially. Since axial forces never act on the ring gear itself, as it is centered via the other elements when not engaged and is fixed relative to the housing when engaged, a very simple axial guide via the axial guide ring is sufficient, which does not have to meet high requirements in terms of mechanical stability or a bearing inside the axial guide ring.

With regard to dispensing with the roller bearing, for example, the rotor shaft of the electric motor is mounted on roller bearings directly opposite the housing and carries the sun gear, meaning that this is also mounted accordingly. The other element would then be the planet carrier, which is also directly mounted on roller bearings relative to the housing. This structure could, of course, be reversed such that the sun gear would be directly mounted on roller bearings relative to the housing and the planet carrier would be indirectly mounted on roller bearings relative to the housing via the rotor shaft. In both cases, the ring gear is indirectly supported on the housing by the interaction with the planetary gears located on the planetary gear carrier and the sun via this bearing of the sun gear on the one hand and the planetary gear carrier on the other and therefore does not require its own direct bearing relative to the housing.

It is still possible to disengage the drive device via the switchable freewheel, such that drag losses can be avoided, e.g., in a situation in which the vehicle is actively driven exclusively by at least one other axle.

The cylinder section thus shifts the possibility of connection in the axial direction and can be connected to a disc unit according to a further very advantageous embodiment in order to non-rotatably connect the cylinder section to the ring gear and the disc unit, which in turn is non-rotatably connected to the ring gear.

Preferably, the rotor of the electric motor can be arranged coaxially to the planetary transmission stage and the disc unit axially on a side of the planetary transmission stage facing away from the rotor. The cylinder section is then located

axially on a side of the disc unit facing away from the planetary transmission stage, such that the rotor, the planetary transmission stage, the disc unit, and the cylinder section follow each other in the axial direction in the aforementioned sequence.

According to an extraordinarily favorable version of this, it can be further provided that the axial guide ring has a U-shaped cross-sectional contour that is open radially outwards. The axial guide ring can thus, for example, axially guide the ring gear itself or a disc connected to the ring gear, for example in the form or as a section of the disc unit, and thus prevent the ring gear from axial displacement. In other words, the axial guide ring has a groove that is open on a radially outward-facing side of the axial guide ring. In this way, a U-shaped cross-sectional contour is formed in a center section of the electric drive device, wherein the U-shaped cross-sectional contour is open at the top in said center section above the axis of rotation. The disc unit advantageously engages in the groove from the radial outside.

According to a further very favorable embodiment of the electric drive device according to the invention, the axial guide ring can be arranged radially inside and axially overlapping with the overrunning clutch. Radially inside again refers to the central axis of rotation of the planetary transmission and indicates that the axial guide ring is located on a smaller diameter than the switchable overrunning clutch. Axially overlapping, also referring to the same axis, means that the two components lie in the same plane perpendicular to the axis of rotation in the axial direction of the axis of rotation of the planetary transmission stage or that both components intersect at least one common plane perpendicular to the axis of rotation.

Another very advantageous embodiment can also provide that the disc unit has a guide section designed to interact with the axial guide ring. Such a guide section of the disc unit can therefore be used to guide the ring gear axially via the axial guide ring as described above. In the preferred embodiment, in which the axial guide ring is arranged radially inside and axially overlapping with the overrunning clutch, the guide section of the disc unit would therefore be provided in this area, preferably as a guide section with two sides that are plane-parallel in the axial direction, which interact accordingly in a guide ring with a U-shaped cross-sectional contour that is open radially outwards and equipped with plane-parallel legs. The guide section advantageously engages in the groove of the axial guide ring.

Particularly advantageously, the axial guide ring is arranged radially inside the cylinder section.

According to a particularly favorable embodiment of the electric drive device for a motor vehicle according to the invention, the switchable overrunning clutch can have a switching disc as a switching element, wherein the actuator is designed to move it rotationally. The switchable overrunning clutch can therefore be designed, in particular, in the sense described in the prior art mentioned at the beginning in the form of DE 10 2019 114 139 B3. It is possible to provide a freewheel, which is designed to lock in the pulling direction as well as in the pushing direction, by the switching element, as well as to lock the connection in both directions of rotation or to release it in both directions of rotation.

The design of the switching disc can preferably also be configured in such a way that only one of the directions can be switched, namely the pull-back direction, which is synonymous with the push-forward direction. This then enables reverse driving and forward recuperation. Switchability for the pull-forward direction, equivalent to the push-backward direction, is not necessarily required. Although this would allow the gear to be separated from the output when travelling in reverse at high speed, i.e., in reverse push mode, this case does not occur in practice, such that the design can be simplified accordingly. The advantage here is that there is only one set of moveable pawls (for one direction) and only one switching disc, which also requires only one actuator.

Another very advantageous design of the electric drive device can also provide that the actuator of the switchable overrunning clutch is arranged in the housing. Such an actuator arranged in the housing is easily accessible if maintenance or the like should become necessary. According to a very advantageous further development, the actuator can be arranged, in particular, radially outside the coupling halves and, or in principle also alternatively, axially overlapping with at least one of the coupling halves. This again saves installation space in the axial direction and the radially external actuator enables simple and, if necessary, easy-to-maintain actuation of the switching disc.

Further advantageous designs of the electric drive device according to the invention emerge from the exemplary embodiment, which is depicted in more detail below with reference to the drawing.

### BRIEF DESCRIPTION OF THE SOLE DRAWING FIGURE

The sole drawing figure shows a schematic sectional view through a part of an electric drive device relevant to the invention.

### DETAILED DESCRIPTION

The sole drawing figure depicts a section of an electric drive device 1. The section is depicted above the axis of rotation A, which also defines the axial direction a and the radial direction r accordingly. An electric motor 2 with a rotor 3 rotates about this axis of rotation A. In the exemplary embodiment depicted here, the electric motor 2 is designed as an axial flux machine. The rotor 3, of which only the half to the right in the electric motor 2 or to the right of the stator 30 is depicted here, is mounted relative to a housing 5 via a rotor bearing 6. In the exemplary embodiment, it is non-rotatably connected to a rotor shaft 4, which is designed in several parts. The rotor shaft 4 is mounted indirectly via the rotor bearing 6 of the rotor 3, which is preferably designed as an angular contact ball bearing, and is also supported on the housing via a needle bearing 28.

On the side of the electric motor 2 facing away in axial direction a, an output 7 to the wheel of the motor vehicle or an axle drive—e.g., a differential—is depicted. This output 7 is non-rotatably connected via the output shaft 18 to a planetary gear carrier 8 as an output element of a planetary transmission stage 13 by means of splined shaft toothing labelled 19.

It is essential for the invention that the planet carrier 8 of the planetary transmission stage 13 is coupled or can be coupled to the output 7 in such a way that torques are transmitted out of the planetary transmission stage via the planet carrier 8.

A sun gear 11 of the planetary transmission stage 13 is coupled or can be coupled to the rotor 3 in such a way that torques, starting from the rotor 3, can be introduced into the planetary transmission stage at the sun gear 11.

The planet carrier 8 has planetary gear pins 9 projecting in the axial direction towards the electric motor 2. Planetary gears 10, one of which can be seen here, are mounted on these planetary gear pins 9 via a planetary gear bearing device 33, which is designed here in the form of two angular contact ball bearings 33.1 and 33.2. The sun gear 11, which is formed by a toothing of the rotor shaft 4, meshes radially on the inside with the planet gears 10. A ring gear 12 completes this structure to form the planetary transmission stage 13 for converting the torque between the rotor 3 and the output 7.

The ring gear 12 does not have its own bearing via its own roller bearing and is supported on the housing 5 via the bearing of the planetary gears 10 or the planetary gear carrier 8 via the two planetary carrier bearings labelled 14.1 and 14.2. In order to ensure that the ring gear 12 cannot perform any significant movements in the axial direction a, an axial guide ring 15 is provided on the housing 5 in the exemplary embodiment shown here, which has a U-shaped contour in cross-section, such that two legs project radially outwards and the U-shaped contour is open radially outwards. A guide section 16, which is designed as a disc ring-shaped extension of a disc unit 17, projects into this U-shaped contour of the axial guide ring 15, which is not a bearing but merely a support for the guide, as an axial bearing is not necessary here. This disc unit 17 is directly non-rotatably connected to the ring gear 12 and therefore rotates at the same angular speed as the ring gear 12.

The electric drive device 1 in the depiction of the sole drawing figure also comprises a switchable freewheel 20 having a first coupling half 21 and a second coupling half 22. The first coupling half 21 is designed as an externally toothed ring and is connected via a freewheel carrier 23, which has radially inwardly directed toothing.

The freewheel carrier 23 is in turn non-rotatably connected to the housing 5. The second coupling half 22 is designed as an annular disc with internal toothing, which sits on a connecting element 24 and is non-rotatably connected to it by the toothing.

The connecting element 24 has a cylindrical section 27 and is non-rotatably connected to the disc unit 17 in order to non-rotatably connect the second coupling half 22 to the ring gear 12 indirectly via the connecting element 24 and the disc unit 17. The switchable freewheel 16 therefore acts on the ring gear 12 such that it either releases or locks a connection between the ring gear 12 and the housing 5 in push or pull operation, depending on the switching position of a switching disc 25 used as a switching element. The switching disc 25 can be moved in rotation via an actuator 26, wherein this actuator 26, which is in operative connection with the switching disc 25 via the connection indicated by the dashed line, is located radially outside the switchable freewheel 20 in the housing 5.

Advantageously, the second coupling half 22 is arranged so as to be axially displaceable relative to the connecting element 24 and axially displaceable relative to the cylinder section 27.

Advantageously, the axially displaceable second coupling half 22 is arranged axially on a side of the first coupling half 21 facing away from the planetary gears 10.

Advantageously, the axial guide ring 15 is arranged radially within the cylinder section 27.

The cylinder section 27 is advantageously arranged radially within the switchable freewheel 20.

Particularly advantageously, the axial guide ring 15 is arranged radially in the area of at least one of the two planet carrier bearings 14.2, 14.2. Advantageously, the axial guide ring 15 is arranged radially overlapping at least one of the two planet carrier bearings 14.2, 14.2.

Particularly advantageously, the axial guide ring is arranged axially overlapping with the second coupling half 22.

For constructional reasons, the switchable freewheel 16 is arranged in the position shown between the ring gear 12 and the housing 5, such that the first coupling half 21 is non-rotatably connected to the housing 5. When the second coupling half 22 is decoupled from the first coupling half 21 and thus from the housing 5, the switching disc 25 holds down the corresponding pawls in a manner analogous to the structure of DE 10 2019 114 139 B3. This is the case in forward thrust mode when the forward thrust side is deactivated. In particular, a non-switchable freewheel function can be arranged in the freewheel 16 between the two coupling halves 21, 22. Between the second coupling half 22 and the housing 5 or the housing-fixed freewheel carrier 23 lies the switching disc 25, which, depending on the switch position, releases or holds down spring-loaded pawls that act in the opposite direction of rotation of the freewheel function between the coupling halves 21, 22, depending on the switch position. This results in two switching states. A freewheel state and a fully coupled brake state in which both directions are locked.

Although the planet carrier 8 still rotates with the driven wheel of the motor vehicle, the ring gear 12 itself is loose in relation to the housing 5, which means that the sun gear 11 is not actually driven, resulting in only low friction losses between the planet gears 10 and the sun gear 11. Despite the very favorable constructive arrangement of the freewheel 16, it can therefore fulfil its tasks with an acceptable degree of efficiency.

This design, in which there is no separate bearing for the ring gear 12, but only an axial guide is provided via the axial guide ring 15, allows a very compact design both in the axial and radial direction of the electric drive device 1 due to the nesting of the elements, which is made possible in particular by the disc unit 17, the cylinder section as a connecting element 24 and the guide section 16.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### REFERENCE NUMERAL LIST

1 electric drive device
2 electric motor
3 rotor
4 rotor shaft
5 housing
6 rotor bearing
7 output
8 planet carrier
9 planetary gear pins
10 planetary gears
11 sun gear
12 ring gear
13 planetary transmission stage
14.1, 14.2 planetary carrier bearings
15 axial guide ring
16 guide section
17 disc unit
18 output shaft
19 splined shaft toothing
20 switchable freewheel
21 first coupling half
22 second coupling half
23 freewheel carrier
24 connecting element
25 switching disc
26 actuator
27 cylinder section (of 24)
28 needle bearing
30 stator
A axis of rotation
a axial direction
r radial direction

1-11. (canceled)

12. An electric drive device for a motor vehicle, the electric drive device comprising:
an electric motor having a rotor;
a planetary transmission stage comprising a sun gear, a planet carrier with planet gears, and a ring gear;
a switchable overrunning clutch comprising a first coupling half, a second coupling half, a switching element and an actuator, wherein the first coupling half is non-rotatably connected to a housing, and wherein the second coupling half is non-rotatably connected to the ring gear;
a connecting element non-rotatably connected to the ring gear and non-rotatably connected to the second coupling half and arranged radially between a sun gear toothing of the sun gear and a ring gear toothing of the ring gear with respect to an axis of rotation of the planetary transmission stage, wherein the connecting element has a cylindrical section arranged coaxially to the axis of rotation of the planetary transmission stage, wherein the cylinder section is arranged radially in relation to the axis of rotation of the planetary transmission stage in a region of planetary gear pins of the planet carrier of the planetary transmission stage carrying the planet gears;
an axial guide ring configured to support the ring gear in both axial directions, wherein the ring gear does not have a rolling bearing directly supporting it; and
a disc unit configured to non-rotatably connect the cylinder section is non-rotatably connected to the ring gear.

13. The electric drive device of claim 12, wherein the rotor is arranged coaxially to the planetary transmission stage, wherein the disc unit is arranged axially on a side of the planetary transmission stage facing away from the rotor, wherein the cylinder section is arranged axially on a side of the disc unit facing away from the planetary transmission stage.

14. The electric drive device of claim 12, wherein the axial guide ring has a U-shaped cross-sectional contour open radially outwards.

15. The electric drive device of claim 12, wherein the axial guide ring is arranged radially within and axially overlapping the overrunning clutch.

16. The electric drive device of claim 12, wherein the disc unit has a guide section configured to co-operate with the axial guide ring.

17. The electric drive device of claim 12, wherein the axial guide ring is arranged radially within the cylinder section.

18. The electric drive device of claim 12, wherein the second coupling half is arranged axially on a side of the first coupling half facing away from the planetary gears.

19. The electric drive device of claim 12, wherein the switching element is a switching disc, and wherein the actuator is configured to move the switching disc in a rotational manner.

20. The electric drive device of claim 12, wherein the actuator of the switchable overrunning clutch is arranged in the housing.

21. The electric drive device of claim 12, wherein the actuator of the switchable overrunning clutch is arranged radially outside the first and second coupling halves or axially overlapping at least one of the first and second coupling halves.
